(19) United States
(12) Patent Application Publication
(10) Pub. No.: US 2020/0089052 A1
(43) Pub. Date: Mar. 19, 2020

(54) LIQUID CRYSTAL MODULE AND LIQUID CRYSTAL DISPLAY DEVICE

(71) Applicant: HUIZHOU CHINA STAR OPTOELECTRONICS TECHNOLOGY CO., LTD., Huizhou Guangdong (CN)

(72) Inventor: Chunchi CHEN, Huizhou Guangdong (CN)

(21) Appl. No.: 15/751,093

(22) PCT Filed: Jan. 19, 2018
(86) PCT No.: PCT/CN2018/073479

§ 371 Date: Feb. 7, 2018

(30) Foreign Application Priority Data
Dec. 28, 2017 (CN) 201711467126.X

(51) Int. Cl. G02F 1/1335; G02F 1/1343; G02F 1/133

(52) U.S. Cl. CPC G02F 1/133602; G02F 1/133615; G02F 1/13306; G02F 1/133514; G02F 1/134309

(57) ABSTRACT

The disclosure discloses a liquid crystal module including a liquid crystal display panel and a backlight unit disposed opposite to each other, and the backlight unit is an edge-lit backlight unit, a liquid crystal light valve is disposed between the backlight unit and the liquid crystal display panel, the liquid crystal light valve comprises a plurality of liquid crystal light sub-valves, the liquid crystal light sub-valves are independently controllable and are configured to control the light flux of the light emitted from the backlight unit incident on the liquid crystal display panel. The disclosure also discloses a liquid crystal display device including the liquid crystal module as described above. The liquid crystal module provided by the embodiment of the disclosure can use the edge-lit backlight to achieve the effect of high dynamic contrast and can meet the requirements of an ultra-thin liquid crystal display device.

### RELATED APPLICATIONS

The present application is a National Phase of International Application Number PCT/CN2018/073479, filed Jan. 19, 2018, and claims the priority of China Application No. 201711467126.X, filed Dec. 28, 2017.

### FIELD OF THE DISCLOSURE

The disclosure relates to the field of liquid crystal display technology, in particular to a liquid crystal module and a liquid crystal display device.

### BACKGROUND

In flat panel display devices, the liquid crystal display devices (LCD) occupy the dominant position in the current flat panel display market due to its characteristics such as small size, low power, relatively low manufacturing cost, and free radiation.

In recent years, with the development of high-dynamic range (HDR) technology, HDR technology is increasingly used in liquid crystal display devices. To realize the HDR technology in a liquid crystal display device, special technical requirements are proposed for the backlight unit of the liquid crystal display device. The backlight unit of the liquid crystal display device should be capable of implementing local dimming of the partition control.

The backlight type of LCD module mainly includes direct backlight and edge-lit backlight. Because the partition of light-emitting diode (LED) light source and the partition of liquid crystal display panel can correspond one by one, the effect of local dimming of the partition is good, the direct backlight has become the mainstream of the market, however, the direct backlight module has a relatively large size and cannot meet the demand of the market for ultra-thin liquid crystal display devices. Although the edge-lit backlight meets the market for ultra-thin liquid crystal display devices, its edge-lit partition control is difficult, so the efficient multi-partition cannot be achieved, so its HDR is less effective.

### SUMMARY

In view of the shortcomings of the existing technology, the disclosure provides a liquid crystal module, which can achieve the effect of HDR with edge-lit backlight and can meet the requirements of the ultra-thin liquid crystal display device.

In order to achieve the above object, the disclosure adopts the following technical solutions:

a liquid crystal module, including a liquid crystal display panel and a backlight unit disposed opposite to each other, and the backlight unit is an edge-lit backlight unit, a liquid crystal light valve is disposed between the backlight unit and the liquid crystal display panel, the liquid crystal light valve includes a plurality of liquid crystal light sub-valves, and the liquid crystal light sub-valves are independently controllable, the liquid crystal light sub-valves are configured to control the light flux of the light emitted from the backlight unit incident on the liquid crystal display panel.

The liquid crystal light sub-valve includes a first electrode plate and a second electrode plate disposed opposite to each other, and a first liquid crystal layer is disposed between the first electrode plate and the second electrode plate.

The first electrode plate includes a first transparent electrode formed on a first glass substrate, and the second electrode plate includes a second transparent electrode formed on a second glass substrate.

A material of the first transparent electrode and the second transparent electrode is ITO.

The liquid crystal display panel includes a plurality of pixel units arranged in an array, and a projection of each of the liquid crystal light sub-valves on the liquid crystal display panel covers a plurality of pixel units.

The liquid crystal display panel includes a thin film transistor array substrate and a color filter substrate disposed opposite to each other, and a second liquid crystal layer is disposed between the thin film transistor array substrate and the color filter substrate.

The liquid crystal light sub-valves are arranged in a matrix array of M rows×N columns, and both M and N are positive integers,

The values of M and N are respectively 2≤M≤100 and 2≤N≤100.

The backlight unit includes a backplane and a reflective sheet, a light guide plate, and an optical film set sequentially disposed on the backplane, and a side surface of the light guide plate includes a light source.

The disclosure further provides a liquid crystal display device including a driving module and a liquid crystal module as described above, and the driving module inputs an image driving signal to the liquid crystal display panel, inputs a backlight driving signal to the backlight unit, and inputs a switch drive signal to the liquid crystal light valve.

In the liquid crystal module provided by the embodiment of the disclosure, the backlight unit thereof adopts a edge-lit backlight unit, which can meet the requirements of the ultra-thin liquid crystal display device; in addition, a liquid crystal light valve is disposed between the backlight unit and the display panel, a plurality of liquid crystal light sub-valves in the liquid crystal light valve perform local dimming of the partition on the light emitted by the backlight unit, according to the requirement of the display screen, the luminous flux incident on the display panel of each block is controlled, thereby realizing the display effect of high dynamic range.

### BRIEF DESCRIPTION OF THE DRAWINGS

FIG. 1 is a schematic structural view of a liquid crystal module according to an embodiment of the disclosure;

FIG. 2 is a schematic structural view of a backlight unit according to an embodiment of the disclosure;

FIG. 3 is a schematic plan view of a liquid crystal light valve according to an embodiment of the disclosure;

FIG. 4 is a cross-sectional structure diagram of a liquid crystal light sub-valve according to an embodiment of the disclosure.

FIG. 5 is a schematic structural view of a liquid crystal display panel according to an embodiment of the disclosure;

FIG. 6 is an exemplary illustration of a projection of a liquid crystal light valve on a liquid crystal display panel according to an embodiment of the disclosure;

FIG. 7 is a schematic structural diagram of a liquid crystal display device according to an embodiment of the disclosure.

### DETAILED DESCRIPTION OF PREFERRED EMBODIMENTS

To make the objectives, technical solutions, and advantages of the disclosure clearer, the following describes the specific implementation manners of the disclosure in detail with reference to the accompanying drawings. Examples of the preferred embodiments are illustrated in the accompanying drawings. The embodiments of the disclosure shown in the drawings and described in the drawings are merely exemplary and the disclosure is not limited to these embodiments.

Here, it should be further noted that in order to prevent the disclosure to be obscured due to unnecessary details, only apparatus structures and/or processing steps closely related to the solution according to the disclosure are shown in the accompanying drawings, while other details having little relations are omitted.

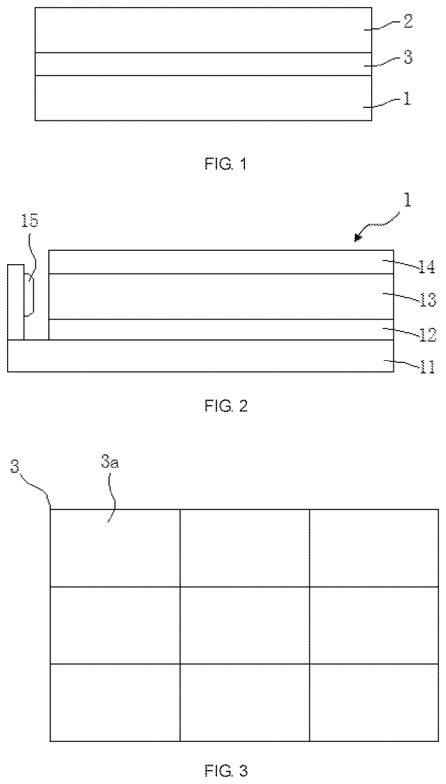

The embodiment firstly provides a liquid crystal module, as shown in FIG. 1, the liquid crystal module includes a liquid crystal display panel 1 and a backlight unit 2 disposed opposite to each other, and a liquid crystal light valve 3 is disposed between the backlight unit 1 and the liquid crystal display panel 2.

As shown in FIG. 2, the backlight unit 1 is an edge-lit backlight unit, the backlight unit 1 includes a backplane 11 and a reflective sheet 12, a light guide plate 13, and an optical film set 14 sequentially disposed on the backplane 11, and a light source 15 is disposed on a side surface of the light guide plate 13.

Specifically, the light source 15 usually employs an LED light, the light emitted from the light source 15 passes by the conduction of the light guide plate 13 and is incident on the optical film set 14 after being reflected by the reflective sheet 12 from the back surface of the light guide plate 13 and then is emitted from the upper surface of the optical film set 14 to provide to the liquid crystal display panel 2. In general, the optical film set 14 includes a prism sheet, an anti-reflective coating, and the like.

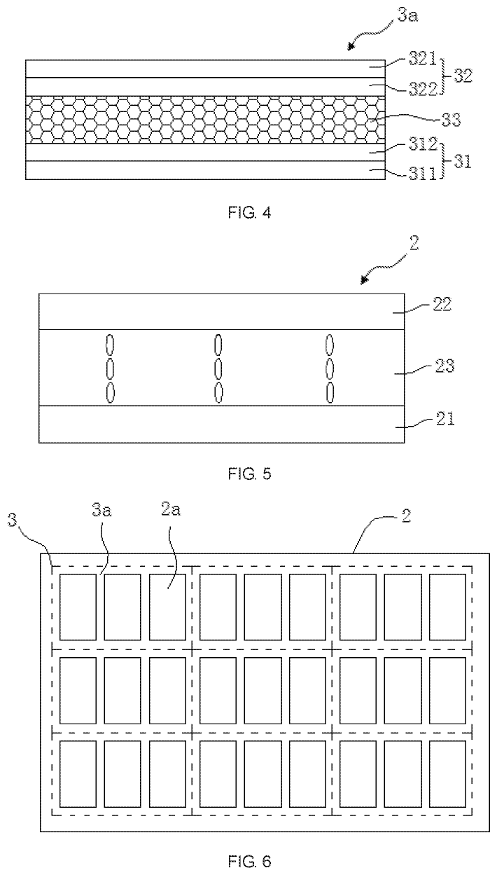

Referring to FIG. 3 and FIG. 4, the liquid crystal light valve 3 includes a plurality of liquid crystal light sub-valves 3a, the liquid crystal light sub-valves 3a are individually controllable. The liquid crystal light sub-valves 3a are disposed on a light-emitting surface of the backlight unit 1, the liquid crystal light sub-valves 3a are configured to control the light flux incident on the liquid crystal display panel 2 by the light emitted from the backlight unit 1, and each of the liquid crystal light sub-valves 3a corresponds to a control partition.

As shown in FIG. 4, the liquid crystal light sub-valve 3a includes a first electrode plate 31 and a second electrode plate 32 disposed opposite to each other, and the first liquid crystal layer 33 is disposed between the first electrode plate 31 and the second electrode plate 32. Specifically, the first electrode plate 31 includes a first transparent electrode 312 formed on the first glass substrate 311, and the second electrode plate 32 includes a second transparent electrode 322 formed on the second glass substrate 321. The material of the first transparent electrode 312 and the second transparent electrode 322 is usually selected from indium tin oxide (ITO). By controlling the voltage difference applied to the first transparent electrode 312 and the second transparent electrode 322, the rotation of the liquid crystal molecules in the first liquid crystal layer 33 is controlled so as to control the light transmittance of the liquid crystal light valve 3a. And a plurality of the liquid crystal light sub-valves 3a are separately and independently controllable, so that the partition control of the luminous flux of light emitted from the backlight unit 1 incident on the liquid crystal display panel 2 can be realized, and the display effect of a high dynamic contrast display by adopting the edge-lit backlight unit is achieved.

Referring to FIGS. 5 and 6, the liquid crystal display panel 2 includes a thin film transistor array substrate 21 and a color filter substrate 22 disposed opposite to each other, and a second liquid crystal layer 23 is disposed between the thin film transistor array substrate 21 and the color filter substrate 22. In the liquid crystal display panel 2, a plurality of pixel units 2a arranged in an array are formed, a number of pixel units 2a are exemplarily shown in FIG. 6.

In this embodiment, referring to FIG. 4 and FIG. 6, in the liquid crystal light valve 3, the area of each of the liquid crystal light sub-valves 3a is equal, and the liquid crystal light sub-valves 3a are arranged in a matrix array of M rows×N columns, and both M and N are positive integers. A projection of each of the liquid crystal light sub-valves 3a on the liquid crystal display panel 2 covers a plurality of pixel units 2a.

The values of M and N determine the number of blocks for partitioning the backlight unit 1. The larger the values of M and N are, the more the blocks of the backlight can be respectively controlled and the better the effect of HDR is. In the structures shown in FIGS. 4 and 6, both M and N have a value of 3. In a more preferred technical solution, the values of M and N are respectively selected from the following ranges: 2≤M≤100 and 2≤N≤100.

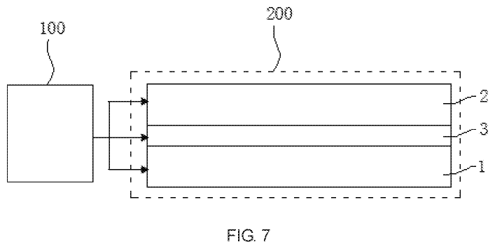

The disclosure further provides a liquid crystal display device, as shown in FIG. 7, the liquid crystal display device includes a driving module 100 and a liquid crystal module 200, the liquid crystal module 200 is a liquid crystal module as described above in this embodiment. The liquid crystal module 200 includes a backlight unit 1, a liquid crystal display panel 2, and a liquid crystal light valve 3. The driving module 100 is respectively connected to the backlight unit 1, the liquid crystal display panel 2, and the liquid crystal light valve 3.

The driving module 100 inputs an input image signal to the liquid crystal display panel 1, so as to make the liquid crystal display panel 1 display a corresponding image. The driving module 100 inputs a backlight driving signal to the backlight unit 1, so as to make the backlight unit 1 generate light to provide to the liquid crystal display panel 2. The driving module 100 further inputs a switch driving signal to the liquid crystal light valve 3, so as to adjust the light transmittance of each of the liquid crystal light sub-valve of the liquid crystal light valve 3 and to control the luminous flux of the light emitted from the backlight unit 1 incident on the liquid crystal display panel 2.

The switch driving signal refers to a voltage signal applied to the electrode plate of the liquid crystal sub-valve. The driving module 100 may divide the image to be displayed into a plurality of areas, each of which corresponds to a liquid crystal light sub-valve, and generate a switch driving signal of the liquid crystal light sub-valve corresponding to the area according to the brightness to be displayed in each of the areas of the image, thereby controlling the luminous flux obtained from the corresponding brightness.

To sum up, in the liquid crystal module and the liquid crystal display device provided in the embodiments of the disclosure, the backlight unit thereof adopts an edge-lit backlight unit, which can meet the requirements of the ultra-thin liquid crystal display device; in addition, a liquid crystal light valve is disposed between the backlight unit and the display panel, a plurality of liquid crystal light sub-valves in the liquid crystal light valve perform local dimming of the partition on the light emitted by the backlight unit, according to the requirement of the display screen, the luminous flux incident on the display panel of each partition is controlled, thereby realizing the display effect of high dynamic range.

It is to be noted that, in the context, relational terms such as first and second are used only to distinguish an entity or an operation from another entity or another operation without necessarily requiring or implying that such entities or operations have any such actual relationship or sequence. Moreover, terms “include”, “comprise” or any other variant thereof is intended to encompass a non-exclusive inclusion such that processes, methods, articles, or devices that include a series of elements include not only those elements but also those that are not explicitly listed. In the absence of more restrictions, the elements defined by the statement “including a . . . ” do not preclude the presence of additional elements in the process, method, article, or device that includes the elements.

It should be indicated that the disclosure can also be improved and modified by those skilled in the art without departing from the principle of the present application, and these improvements and modifications also fall within the protection scope of the claims of the disclosure.

What is claimed is:

1. A liquid crystal module, comprising:
a liquid crystal display panel; and
a backlight unit disposed opposite to the liquid crystal display panel;
wherein the backlight unit is an edge-lit backlight unit, a liquid crystal light valve is disposed between the backlight unit and the liquid crystal display panel, the liquid crystal light valve comprises a plurality of liquid crystal light sub-valves, the liquid crystal light sub-valves are independently controllable, and the liquid crystal light sub-valves are configured to control a light flux of the light emitted from the backlight unit incident on the liquid crystal display panel.

2. The liquid crystal module according to claim 1, wherein the liquid crystal light sub-valve comprises a first electrode plate and a second electrode plate disposed opposite to each other, and a first liquid crystal layer is disposed between the first electrode plate and the second electrode plate.

3. The liquid crystal module according to claim 2, wherein the first electrode plate comprises a first transparent electrode formed on a first glass substrate, and the second electrode plate comprises a second transparent electrode formed on a second glass substrate.

4. The liquid crystal module according to claim 3, wherein a material of the first transparent electrode and the second transparent electrode is ITO.

5. The liquid crystal module according to claim 2, wherein the liquid crystal display panel comprises a plurality of pixel units arranged in an array, and a projection of each of the liquid crystal light sub-valves on the liquid crystal display panel covers a plurality of pixel units.

6. The liquid crystal module according to claim 5, wherein the liquid crystal display panel comprises a thin film transistor array substrate and a color filter substrate disposed opposite to each other, and a second liquid crystal layer is disposed between the thin film transistor array substrate and the color filter substrate.

7. The liquid crystal module according to claim 1, wherein the liquid crystal light sub-valves are arranged in a matrix array of M rows×N columns, and both M and N are positive integers.

8. The liquid crystal module according to claim 7, wherein values of M and N are respectively 2≤M≤100 and 2≤N≤100.

9. The liquid crystal module according to claim 1, wherein the backlight unit comprises a backplane and a reflective sheet, a light guide plate, and an optical film set sequentially disposed on the backplane, and a light source is disposed on a side surface of the light guide plate.

10. A liquid crystal display device, comprising:
a driving module; and
a liquid crystal module;
wherein the liquid crystal module comprises a liquid crystal display panel and a backlight unit disposed opposite to each other, the backlight unit is an edge-lit backlight unit, a liquid crystal light valve is disposed between the backlight unit and the liquid crystal display panel, the liquid crystal light valve comprises a plurality of liquid crystal light sub-valves, the liquid crystal light sub-valves are independently controllable, and the liquid crystal light sub-valves are configured to control the light flux of the light emitted from the backlight unit incident on the liquid crystal display panel;
wherein the driving module inputs an image driving signal to the liquid crystal display panel, inputs a backlight driving signal to the backlight unit, and inputs a switch driving signal to the liquid crystal light valve.

11. The liquid crystal display device according to claim 10, wherein the liquid crystal light sub-valve comprises a first electrode plate and a second electrode plate disposed opposite to each other, and a first liquid crystal layer is disposed between the first electrode plate and the second electrode plate.

12. The liquid crystal display device according to claim 11, wherein the first electrode plate comprises a first transparent electrode formed on a first glass substrate, and the second electrode plate comprises a second transparent electrode formed on a second glass substrate.

13. The liquid crystal display device according to claim 12, wherein a material of the first transparent electrode and the second transparent electrode is ITO.

14. The liquid crystal display device according to claim 11, wherein the liquid crystal display panel comprises a plurality of pixel units arranged in an array, and a projection of each of the liquid crystal light sub-valves on the liquid crystal display panel covers a plurality of pixel units.

15. The liquid crystal display device according to claim 14, wherein the liquid crystal display panel comprises a thin film transistor array substrate and a color filter substrate disposed opposite to each other, and a second liquid crystal layer is disposed between the thin film transistor array substrate and the color filter substrate.

16. The liquid crystal display device according to claim 10, wherein the liquid crystal light sub-valves are arranged in a matrix array of M rows×N columns, and both M and N are positive integers.

17. The liquid crystal display device according to claim 16, wherein values of M and N are respectively 2≤M≤100 and 2≤N≤100.

18. The liquid crystal display device according to claim 10, wherein the backlight unit comprises a backplane and a reflective sheet, a light guide plate, and an optical film set sequentially disposed on the backplane, and a light source is disposed on a side surface of the light guide plate.
